(19) United States
(12) Patent Application Publication
(10) Pub. No.: US 2017/0350578 A1
(43) Pub. Date: Dec. 7, 2017

(54) LIGHT EMITTING DIODE LAMP

(71) Applicant: ENERGY PRO TECHNOLOGY CO., LTD., Changhua County (TW)

(72) Inventor: Shih-Hsien CHANG, Changhua County (TW)

(21) Appl. No.: 15/173,576

(22) Filed: Jun. 3, 2016

(51) Int. Cl. F21V 23/00; F21V 19/00; F21V 23/02; H05B 33/08

(52) U.S. Cl. CPC F21V 23/005; H05B 33/0815; F21V 19/003; F21V 23/02

(57) ABSTRACT

An LED lamp is provided. The LED lamp includes a lamp shell and an LED module. The lamp shell includes a socket. The LED module is assembled with the lamp shell, and the LED module includes a circuit board, a plurality of LEDs, and an electronic circuit. The LEDs are electrically connected to the electronic circuit by conductive traces provided on a surface of the circuit board. The LEDs mounted on the other surface of the circuit board are arranged at a center thereof and surrounded by the electronic circuit. The LED module is assembled with the lamp shell, and the socket of the LED lamp is connectable to a power conversion device capable of providing electric power to high-pressure sodium lamp.

### BACKGROUND

### Technical Field

The present disclosure relates to a light emitting diode (LED) lamp. More particularly, the present disclosure relates to an LED lamp which is used for replacing the high-pressure sodium lamp.

### Description of Related Art

A sodium lamp is a gas-discharge lamp that uses sodium in an excited state to produce light. There are two varieties of such lamps: low pressure and high pressure. Low-pressure sodium lamps only give monochromatic yellow light, but their yellow light restricts applications to outdoor lighting such as street lamps. High-pressure sodium lamps have a broader spectrum of light than the low-pressure lamps. They have been widely used for outdoor area lighting such as streetlights, freeway, airport, wharf, dock, railroad station, plaza, mining industry, park and courtyard. They are also common used as plant grow lights.

The high-pressure sodium light has advantages of allowing the light penetrate fog and rain with minimum of dispersion, and is less attractive to insects. However, the high-pressure sodium light is bulky, low luminous efficiency, and slow response time, and cannot provide a proper visible environment for driver since poorer color rendering than other types of lamps (such as LED lamps).

### SUMMARY

According to one aspect of the present disclosure, a light emitting diode lamp connectable to a socket holder of a power conversion device includes a lamp shell, a socket, and an LED module. The socket and the LED module are respectively assembled with the lamp shell. The LED module includes a circuit board, a plurality of LEDs, and an electronic circuit. The circuit board is provided with conductive traces on a surface thereof. The LEDs are mounted on the other surface of the circuit board and electrically connected to the conductive traces. The electronic circuit is mounted on the surface mounted with the LEDs and electrically connected to the conductive traces. The LEDs arranged at a center of the circuit board and surrounded with the electronic circuit are electrically connected to the electronic circuit via the conductive traces, and the electronic circuit is electrically connected to the socket for receiving electric power required by the LEDs.

In an embodiment of the present disclosure, at least one penetrating hole is formed on the circuit board, and the penetrating hole is applied to fasten the circuit board on the lamp shell.

In an embodiment of the present disclosure, the LED lamp further comprises an enclosure assembled with the lamp shell and encloses the LED module.

In an embodiment of the present disclosure, the electronic circuit comprising an input terminal, a rectifying unit, a filtering unit, and an output terminal. The input terminal is electrically connected to the socket. The rectifying unit is electrically connected to the input terminal and configured to converting an electric power entering the rectifying unit into a direct current (DC) electric power. The filtering unit is electrically connected to the rectifying unit and configured to filter ripple existing in the DC electric power. The output terminal is electrically connected to the filtering unit and the LEDs, and the LEDs are driven to light by the DC electric power which the ripple is filtered.

In an embodiment of the present disclosure, the rectifying unit comprising a plurality of rectifying diodes electrically connected to each other.

In an embodiment of the present disclosure, the filtering unit is a capacitor.

In an embodiment of the present disclosure, the power conversion device comprising a transformer and a current-limiting unit electrically connected to an output of the transformer, and an output of the current-limiting unit is electrically connected to the socket.

### BRIEF DESCRIPTION OF DRAWING

The present disclosure can be more fully understood by reading the following detailed description of the embodiment, with reference made to the accompanying drawings as follows:

FIG. 1 is a top view of a light emitting diode (LED) module according to the present disclosure;

FIG. 2 is a circuit diagram of the LED module according to the present disclosure;

FIG. 3 is a schematic view of a LED lamp and a power conversion device according to the present disclosure; and

FIG. 4 is a circuit diagram of the LED lamp and the power conversion module according to the present disclosure.

### DETAILED DESCRIPTION

A preferred embodiment of the present disclosure will be described with reference to the drawings.

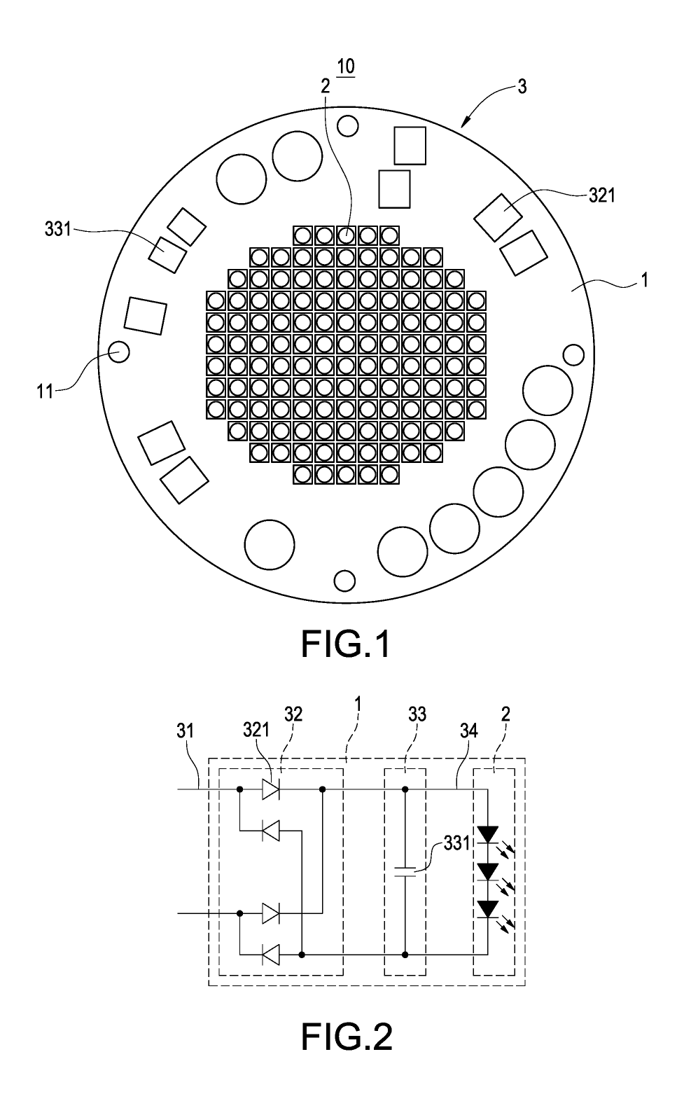

Reference is made to FIG. 1, which is a top view of a light emitting diode (LED) module of the present disclosure. In FIG. 1, the LED device 10 includes a circuit board 1, a plurality of light emitting diodes (LEDs) 2, and an electronic circuit 3. The circuit board 1 is provided with conductive traces (not shown); the conductive traces are placed on a surface of the circuit board 1. The circuit board 1 is further provided with at least one penetrating holes 11 applied to fasten the circuit board 1 on the lamp shell (not shown). The LEDs 2 and a plurality of electronic components 321 and 331 of the electronic circuit 3 are mounted on the other surface of the circuit board 1, and the LEDs 2 and the electronic components 321 and 331 are electrically connected to the conductive traces. Specifically, the terminals (not shown) of the LEDs 2 and the electronic components 321 and 331 are respectively penetrated the circuit board 1 and connected to the conductive traces, thus the LEDs 2 can be electrically connected to the electronic components 321 and 331 by the conductive traces. The electronic components 321 and 331 are further electrically connected to a socket (not shown) assembled with the lamp shell for receiving an electric power required by the LEDs 2.

Furthermore, the LEDs 2 are arranged at the center of the surface of the circuit board 1. The electronic components 321 and 331 surrounds the LEDs 2, as such light emitted from the LEDs cannot shield by the electronic components 321 and 331.

Reference is made to FIG. 2, which is a circuit diagram of the LED module according to the present disclosure. The electronic circuit 3 includes an input terminal 31, a rectifying unit 32, a filtering unit 33, and an output terminal 34.

The input terminal 31 is electrically connected to the socket of the LED lamp.

The rectifying unit 32 is electrically connected to the input terminal 31 and configured to convert an electric power (such as an alternative current (AC) electric power) into a pulsating direct current (DC) electric power. The rectifying unit 32 includes a plurality of electronic components 321 electrically connected to each other, and the electronic components 321 are, for example, rectifying diodes.

The filtering unit 33 is electrically connected to the rectifying unit 32 and configured to remove the unwanted AC components (called ripple) of the rectifying unit 32 output, thus the filtering unit 22 can output a smooth and steady DC electric power. In FIG. 2, the filtering unit 33 includes the electronic component 331, and the electrical component 331 is, for example, a capacitor 331.

The output terminal 34 is electrically to the filtering unit 33 and the LEDs 2, and the LEDs 2 are driven to light by the smooth and steady DC electric power outputted from the filtering unit 22.

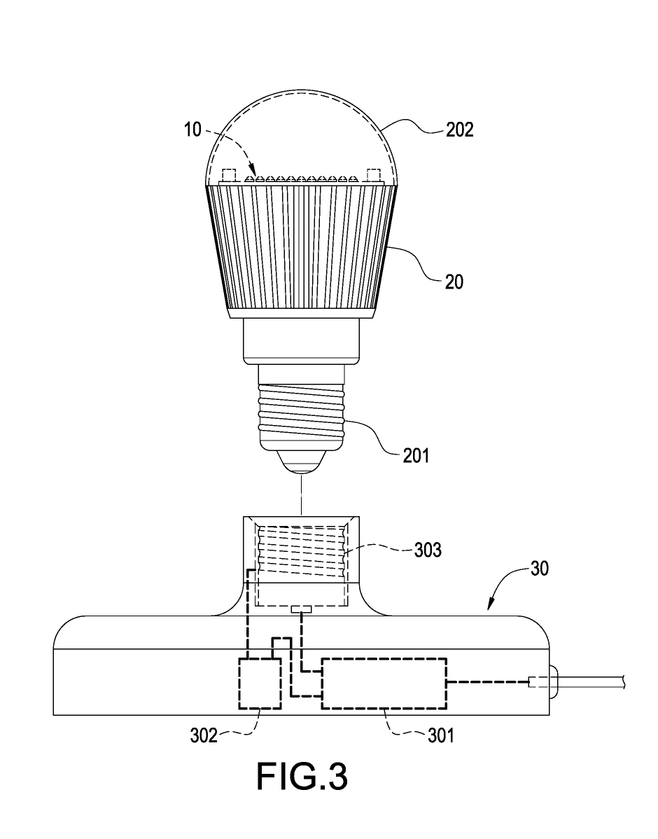

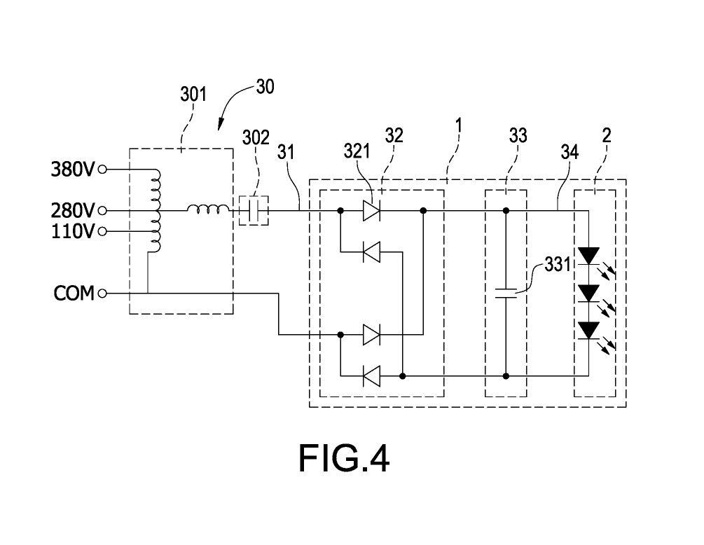

Reference is made to FIG. 3 and FIG. 4. FIG. 3 is a schematic view of a LED lamp and a power conversion device according to the present disclosure; FIG. 4 is a circuit diagram of the LED lamp and the power conversion device according to the present disclosure. The LED module 10 is assembled with a lamp shell 20. The lamp shell 20 is further assembled with a socket (such as E40 socket) 201, wherein the LED module 10 and the socket 201 are arranged at opposite sides of the lamp shell 20. An enclosure 202 is further assembled with the lamp shell 20 and encloses the LED module 10. Thus an LED lamp is formed. In operation, the LED lamp is adapted to the power conversion device 30 used to provide electric power to conventional high-pressure sodium lamp. The power conversion device 30 includes a transformer 301 and a current-limiting unit 302, and a socket adaptor 303; the current-limiting unit 302 is arranged between the transformer 301 and the socket adapter 303 and electrically connected thereto. The current-limiting unit 302 is configured to limit the current transmitted to the LEDs 2 for preventing the LEDs from over-current damage.

In operation, the socket 201 assembled with the lamp shell 20 of the LED lamp is installed in the socket holder 303 of the power conversion module 20. An AC electric power enters the power conversion module 30 is converted by the transformer 310 and the current-limiting unit 302 accordingly, and then transmitted to the socket holder 303. The AC electric power enters to the LED lamp thereafter. The AC electric power entering the LED lamp is first transmitted to the rectifying unit 32; the rectified unit 32 converts the AC electric power provided by the power conversion module 30 into the pulsating DC electric power, and the pulsating DC electric power is then transmitted to the filtering unit 33. The rectifying unit 33 removes the ripple of the pulsating DC electric power, and output the smooth and steady DC electric power to the LEDs 2 for driving the LEDs 2 to light.

When the LED lamp 20 is failure or damage, the LED lamp 20, a user can individually replace the LED lamp 20 by screwing the socket 201 from the socket holder 303 and install another LED lamp 20 onto the power conversion module 30.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the disclosure as defined in the appended claims.

What is claimed is:

1. A light emitting diode (LED) lamp connectable to a socket holder of a power conversion device, the LED lamp comprising:
a lamp shell;
a socket assembled with the lamp shell;
an LED module assembled with the lamp shell, the LED module comprising:
a circuit board provided with conductive traces, wherein the conductive traces are placed on a surface of the circuit board;
a plurality of light emitting diodes (LEDs) mounted on the other surface of the circuit board and electrically connected to the conductive traces; and
an electronic circuit mounted on the surface mounted with the LEDs and electrically connected to the conductive traces,
wherein the LEDs arranged at a center of the circuit board and surrounded with the electronic circuit are electrically connected to the electronic circuit via the conductive traces, and the electronic circuit is electrically connected to the socket for receiving electric power required by the LEDs.

2. The LED lamp of claim 1, wherein at least one penetrating hole is formed on the circuit board, the penetrating hole is applied to fasten the circuit board on the lamp shell.

3. The LED lamp of claim 2, further comprising an enclosure assembled with the lamp shell and enclosing the LED module.

4. The LED lamp of claim 3, wherein the electronic circuit comprising:
an input terminal electrically connected to the socket;
a rectifying unit electrically connected to the input terminal and configured to converting an electric power entering the rectifying unit into a direct current (DC) electric power;
a filtering unit electrically connected to the rectifying unit and configured to filter ripple existing in the DC electric power; and
an output terminal electrically connected to the filtering unit and the LEDs, wherein the LEDs are driven to light by the DC electric power which the ripple is filtered.

5. The LED lamp of claim 4, wherein the rectifying unit comprising a plurality of rectifying diodes electrically connected to each other.

6. The LED lamp of claim 5, wherein the filtering unit is a capacitor.

7. The LED lamp of claim 6, wherein the power conversion device comprising:
a transformer; and
a current-limiting unit electrically connected to an output of the transformer, wherein an output of the current-limiting unit is electrically connected to the socket.
